(19) United States
(12) Patent Application Publication
(10) Pub. No.: US 2025/0104405 A1
(43) Pub. Date: Mar. 27, 2025

(54) ATTRIBUTING PREDICTIVE UNCERTAINTIES IN REAL-WORLD CLASSIFICATION WITH ADVERSARIAL GRADIENT AGGREGATION

(71) Applicant: Robert Bosch GmbH, Stuttgart (DE)

(72) Inventors: XIN LI, Sunnyvale, CA (US); LIANG GOU, San Jose, CA (US); LIU REN, Saratoga, CA (US)

(21) Appl. No.: 18/372,490

(22) Filed: Sep. 25, 2023

(51) Int. Cl. G06V 10/776; G06V 10/764; G06V 10/774; G06V 10/82

(52) U.S. Cl. CPC G06V 10/776; G06V 10/764; G06V 10/774; G06V 10/82

(57) ABSTRACT

A method of obtaining an uncertainty attribution of a prediction of objects in an input image includes receiving an input image, generating a prediction of objects in the input image, estimating an uncertainty associated with the prediction of the objects in the input image, calculating an uncertainty attribution that represents regions of the input image that cause the estimated uncertainty, including generating a plurality of adversarial gradients each corresponding to a modification of the input image configured to change the estimated uncertainty, and generating an output indicative of the calculated uncertainty attribution.

### TECHNICAL FIELD

The present disclosure relates to object detection, and more particularly to determining model uncertainties in object detection systems and methods.

### BACKGROUND

Object detection techniques may use various detection models to detect or predict, classify, and label objects and regions in captured images. A detection model typically has an associated uncertainty (e.g., a predictive or prediction uncertainty) indicative of a level of confidence in predictions of the model.

### SUMMARY

A method of obtaining an uncertainty attribution of a prediction of objects in an input image includes receiving an input image, generating a prediction of objects in the input image, estimating an uncertainty associated with the prediction of the objects in the input image, calculating an uncertainty attribution that represents regions of the input image that cause the estimated uncertainty, including generating a plurality of adversarial gradients each corresponding to a modification of the input image configured to change the estimated uncertainty, and generating an output indicative of the calculated uncertainty attribution.

In other features, generating the plurality of adversarial gradients includes at least one of introducing noise into the input image and modifying selected pixels of the input image. Generating the plurality of adversarial gradients includes identifying at least one adversarial gradient that causes the estimated uncertainty to decrease below a threshold. Generating the plurality of adversarial gradients includes identifying a one of the adversarial gradients that causes the estimated uncertainty to decrease below a threshold with a least amount of modification of the input image. Calculating the uncertainty attribution includes identifying an uncertainty attribution for a selected class of objects.

In other features, the method further includes identifying the uncertainty attribution in accordance with

$${attr}_{i}^{c} = - {\int }_{til certain} {∇}_{{x}_{i}} H ( x ) \cdot \frac{{∇}_{{x}_{i}} {f}_{c} ( x )}{\vert {∇}_{x} {f}_{c} ( x ) \vert} d α ,$$

and attrᵢ^{c} corresponds to the uncertainty attribution of a class c along an integration path, H(x) corresponds to an uncertainty, and ƒ_{c}(x) corresponds to a classification score for the class c and an input x. The method further includes modifying the input image based on the calculated uncertainty attribution and generating a second prediction of the objects in the modified input image, and modifying the input image includes masking portions of the image corresponding to the calculated uncertainty attribution.

A computing device configured to obtain an uncertainty attribution of a prediction of objects in an input image includes a processing device configured to execute instructions stored in memory to receive an input image generate a prediction of objects in the input image, estimate an uncertainty associated with the prediction of the objects in the input image, calculate an uncertainty attribution that represents regions of the input image that cause the estimated uncertainty, including generating a plurality of adversarial gradients each corresponding to a modification of the input image configured to change the estimated uncertainty, and generate an output indicative of the calculated uncertainty attribution.

In other features, to generate the plurality of adversarial gradients, the processing device is configured to execute instructions to at least one of introduce noise into the input image and modify selected pixels of the input image. To generate the plurality of adversarial gradients, the processing device is configured to execute instructions to identify at least one adversarial gradient that causes the estimated uncertainty to decrease below a threshold. To generate the plurality of adversarial gradients, the processing device is configured to execute instructions to identify a one of the adversarial gradients that causes the estimated uncertainty to decrease below a threshold with a least amount of modification of the input image. To calculate the uncertainty attribution, the processing device is configured to execute instructions to identify an uncertainty attribution for a selected class of objects.

In other features, the processing device is configured to execute instructions to identify the uncertainty attribution in accordance with

$${attr}_{i}^{c} = - {\int }_{til certain} {∇}_{{x}_{i}} H ( x ) \cdot \frac{{∇}_{{x}_{i}} {f}_{c} ( x )}{\vert {∇}_{x} {f}_{c} ( x ) \vert} d α ,$$

and attrᵢ^{c} corresponds to the uncertainty attribution of a class c along an integration path, H(x) corresponds to an uncertainty, and ƒ_{c}(x) corresponds to a classification score for the class c and an input x. The processing device is configured to execute instructions to modify the input image based on the calculated uncertainty attribution and generate a second prediction of the objects in the modified input image, and, to modify the input image, the processing device is configured to execute instructions to mask portions of the image corresponding to the calculated uncertainty attribution.

A computer-controlled machine includes at least one sensor configured to generate an input image, a control system configured to receive an input image, generate a prediction of objects in the input image, estimate an uncertainty associated with the prediction of the objects in the input image, calculate an uncertainty attribution that represents regions of the input image that cause the estimated uncertainty, including generating a plurality of adversarial gradients each corresponding to a modification of the input image configured to change the estimated uncertainty, and generate an output signal indicative of the calculated uncertainty attribution, and an actuator configured to control an operation of the computer-controlled machine in response to the output signal.

In other features, to generate the plurality of adversarial gradients, the control system is configured to execute instructions to at least one of introduce noise into the input image and modify selected pixels of the input image. To generate the plurality of adversarial gradients, the control system is configured to execute instructions to identify at least one adversarial gradient that causes the estimated uncertainty to decrease below a threshold. To generate the plurality of adversarial gradients, the processor is configured to execute instructions to identify a one of the adversarial gradients that causes the estimated uncertainty to decrease below a threshold with a least amount of modification of the input image. The control system is configured to execute instructions to modify the input image based on the calculated uncertainty attribution and generate a second prediction of the objects in the modified input image. The computer-controlled machine includes an autonomous robot.

### BRIEF DESCRIPTION OF THE DRAWINGS

FIG. 1 generally illustrates a system for training a neural network according to the principles of the present disclosure.

FIG. 2 generally illustrates a computer-implemented method for training and utilizing a neural network according the principles of the present disclosure.

FIG. 3A generally illustrates an audio data labeling system according to the principles of the present disclosure.

FIG. 3B generally illustrates a portion of a data capturing system according to the principles of the present disclosure.

FIG. 3C generally illustrates an alternative audio data labeling system, according to the principles of the present disclosure.

FIG. 4A generally illustrates an example uncertainty attribution process of the systems and methods of the present disclosure.

FIG. 4B generally illustrates example uncertainty attributions obtained in accordance with the principles of the present disclosure.

FIG. 4C generally illustrates an example quantitative evaluation of the systems and methods of the present disclosure.

FIG. 4D illustrates steps of an example uncertainty attribution method according to the principles of the present disclosure.

FIG. 5 depicts a schematic diagram of an interaction between a computer-controlled machine and a control system according to the principles of the present disclosure.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to the principles of the present disclosure.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Capturing perceptual uncertainties in machine-learning models is indispensable for critical applications for object detection. Model uncertainties often manifest aspects of a system or data-generating process that are not exactly understood, such as sensor noise or a lack of diversity of representation data used during training. The ability to quantify and attribute such uncertainties to their source can aid users in gaining a thorough understanding of the cause of the uncertainty, hence facilitating interpretability in critical applications like autonomous driving. In sensitive contexts, domain experts might employ uncertainty explanations to focus their attention on the specific features that the model identifies as anomalous.

Consequently, object detection systems and methods may implement uncertainty estimate techniques for the purpose of active learning or out-of-distribution detection. In some examples, mechanisms for the attribution of predictive uncertainties to input features may be implemented. For example, gradient-based interpretation methods such as integrated gradients (IG) interpretation methods can be adapted to attribute uncertainty to input features. However, IG interpretation explicitly requires a reference that a model can predict with certainty. Methods using black, white, or blurred images as references leads to a poor performance to attribute uncertainty. Accordingly, other methods train an auxiliary deep generative model to create possible changes to the input such that the model becomes more certain in its prediction. Uncertainty can be characterized by comparing the difference between the original input and generated references. In another example, the reference generated by the deep generative model for IG interpretation is used to attribute the uncertainty of the model. However, these methods rely greatly on the performance of the generative model, which can be troublesome when the underlying task is complicated.

Uncertainty attribution systems and methods according to the present disclosure are configured to more accurately interpret uncertainty in real-world settings. These systems and methods avoid the need for realistic counterfactual examples and are therefore applicable to complex datasets. For example, the need for a generative model can be minimized by using gradients to find adversarial examples for the model. Instead of misleading the model, the objective of searching for adversarial examples is to increase the certainty of the model. Consequently, adversarial examples can serve as a reference for IG interpretation to interpret model uncertainty. Since adversarial examples are well-defined and simple to generate, the systems and methods of the present disclosure are configured to process high-resolution, complicated datasets in real-world settings.

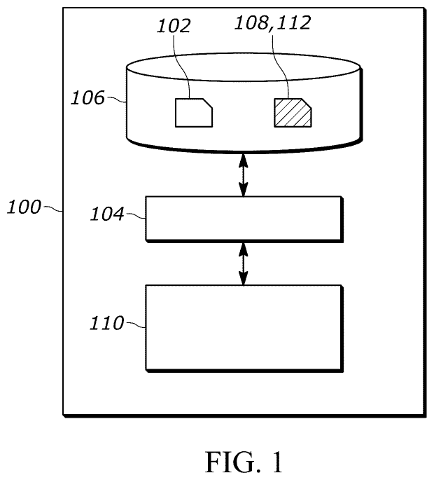

FIG. 1 shows one example system 100 for training a neural network (e.g., of an ML model). The system 100 may be configured to (and/or include circuitry configured to) implement the systems and methods of the present disclosure described below in more detail. The system 100 may comprise an input interface for accessing training data 102 for the neural network. For example, as illustrated in FIG. 1, the input interface may be constituted by a data storage interface 104 which may access the training data 102 from data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also external data storage, e.g., network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from different data storage, e.g., via a different subsystem of the data storage interface 104. Each subsystem may be of a type as is described above for the data storage interface 104.

In some embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive, as input, an output of a previous layer, or for a first layer of the stack of layers, an initial activation, and a part of the input of the stack of layers.

The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network.

The system 100 may further comprise an output interface for outputting a data representation 112 of the trained neural network. This data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may, during or after the training, be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In some embodiments, the data representation 112 may be stored separately from the data representation 108 defining the ‘untrained’ neural network. In some embodiments, the output interface may be separate from the data storage interface 104, but may in general be of a type as described above for the data storage interface 104.

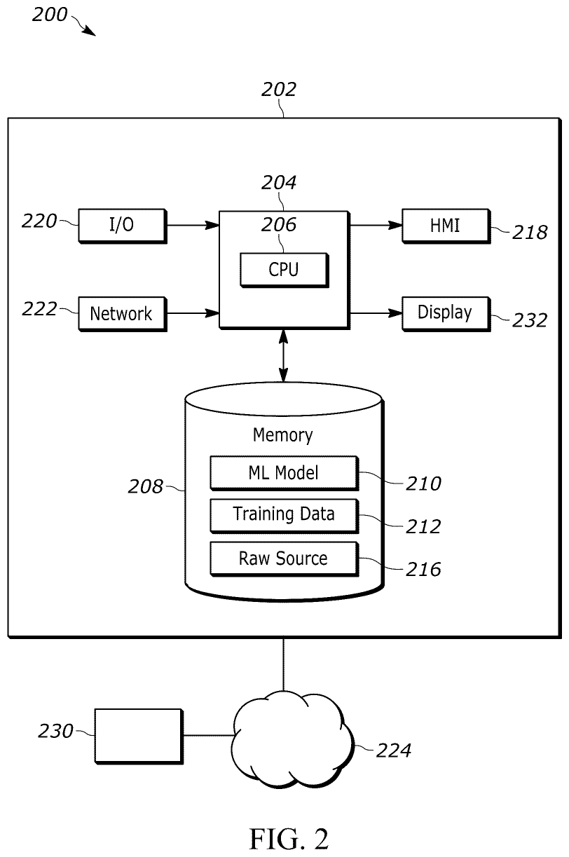

FIG. 2 depicts a data annotation/augmentation system 200 configured to (and/or including circuitry configured to) implement a system for annotating and/or augmenting data. The data annotation system 200 may include at least one computing system 202 configured to implement all or portions of the systems and methods of the present disclosure explained below in more detail. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. Various components of the system 200 may be implemented with same or different circuitry.

During operation, the CPU 206 may execute stored program instructions that are retrieved from the memory unit 208. The stored program instructions may include software that controls operation of the CPU 206 to perform the operation described herein. In some embodiments, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 (e.g., represented in FIG. 2 as the ML Model 210) or algorithm, a training dataset 212 for the machine-learning model 210, raw source dataset 216, etc.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning model 210 that is configured to analyze the raw source dataset 216. For example, the CPU 206 and/or other circuitry may implement the machine-learning model 210. The raw source dataset 216 may include raw or unprocessed sensor data that may be representative of an input dataset for a machine-learning system. The raw source dataset 216 may include video, video segments, images, audio, text-based information, and raw or partially processed sensor data (e.g., radar map of objects). In some embodiments, the machine-learning model 210 may be a deep-learning or neural network algorithm that is designed to perform a predetermined function. For example, the neural network algorithm may be configured to identify events or objects in video segments based on audio data.

The computer system 200 may store the training dataset 212 for the machine-learning model 210. The training dataset 212 may represent a set of previously constructed data for training the machine-learning model 210. The training dataset 212 may be used by the machine-learning model 210 to learn weighting factors associated with a neural network algorithm. The training dataset 212 may include a set of source data that has corresponding outcomes or results that the machine-learning model 210 tries to duplicate via the learning process.

The machine-learning model 210 may be operated in a learning mode using the training dataset 212 as input. The machine-learning model 210 may be executed over a number of iterations using the data from the training dataset 212. With each iteration, the machine-learning model 210 may update internal weighting factors based on the achieved results. For example, the machine-learning model 210 can compare output results (e.g., annotations) with those included in the training dataset 212. Since the training dataset 212 includes the expected results, the machine-learning model 210 can determine when performance is acceptable. After the machine-learning model 210 achieves a predetermined performance level (e.g., 100% agreement with the outcomes associated with the training dataset 212), the machine-learning model 210 may be executed using data that is not in the training dataset 212. The trained machine-learning model 210 may be applied to new datasets to generate annotated data.

The machine-learning model 210 may be configured to identify a particular feature in the raw source data 216. The raw source data 216 may include a plurality of instances or input dataset for which annotation results are desired (e.g., a video stream or segment including audio data). For example only, the machine-learning model 210 may be configured to identify objects or events in a video segment based on audio data and annotate the events. The machine-learning model 210 may be programmed to process the raw source data 216 to identify the presence of the particular features. The machine-learning model 210 may be configured to identify a feature in the raw source data 216 as a predetermined feature. The raw source data 216 may be derived from a variety of sources. For example, the raw source data 216 may be actual input data collected by a machine-learning system. The raw source data 216 may be machine generated for testing the system. As an example, the raw source data 216 may include raw video and/or audio data from a camera, audio data from a microphone, etc.

In an example, the machine-learning model 210 may process raw source data 216 and output video and/or audio data including one or more indications of an identified event. The machine-learning model 210 may generate a confidence level or factor for each output generated. For example, a confidence value that exceeds a predetermined high-confidence threshold may indicate that the machine-learning model 210 is confident that the identified event (or feature) corresponds to the particular event. A confidence value that is less than a low-confidence threshold may indicate that the machine-learning model 210 has some uncertainty that the particular feature is present.

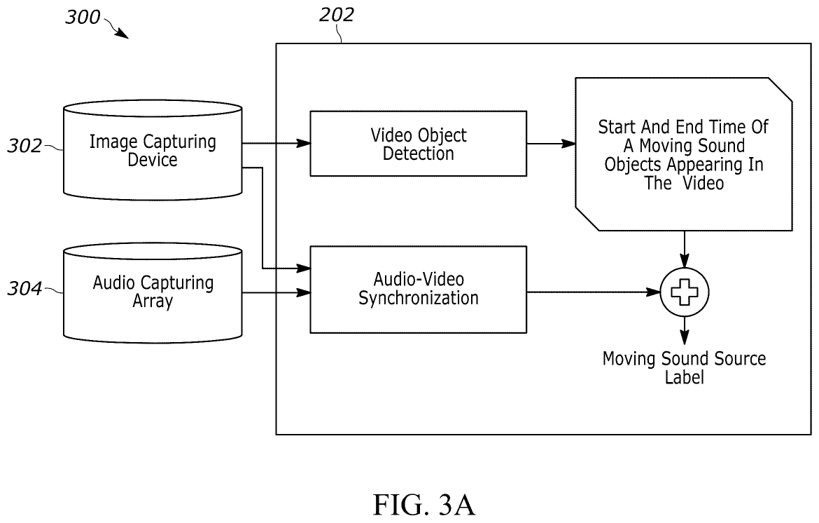

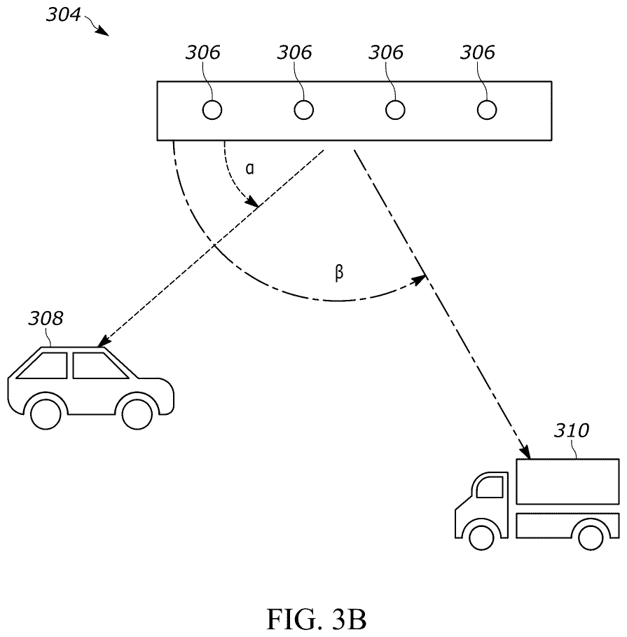

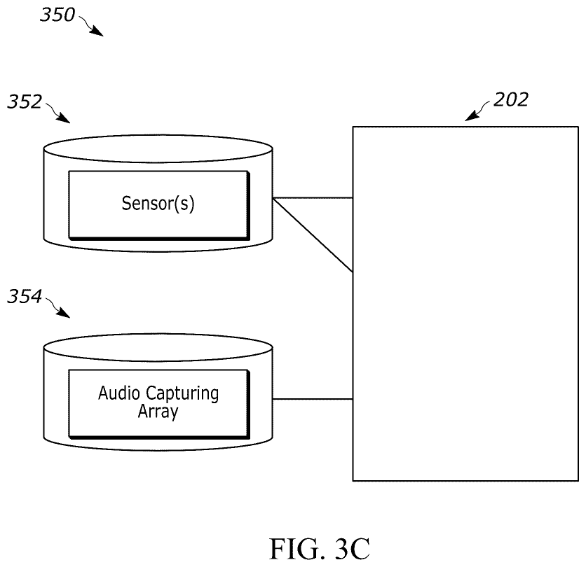

As is generally illustrated in FIGS. 3A and 3B, a system 300 may include an image (e.g., video) capturing device 302, an audio capturing array 304, and the computing system 202. The system may receive, from the image capturing device 302, video stream data associated with a data capture environment. The system 202 may be configured to perform video object detection to identify one or more objects in corresponding images of the video stream data. The system 202 may receive, from the audio capturing array 304, audio stream data that corresponds to at least a portion of the video stream data. The audio capturing array 304 may include one or more microphones 306 or other suitable audio capturing devices. The systems and methods described herein may be configured to label, using output from at least a first machine-learning model (e.g., such as the machine-learning model 210 or other suitable machine-learning model configured to provide output including one or more object or event detection predictions), at least some objects of the video stream data and/or audio stream data.

The system 202 may calculate (e.g., using at least one probabilistic-based function or other suitable technique or function), based on at least one data capturing characteristic, at least one offset value for at least a portion of the audio stream data that corresponds to at least one labeled object of the video stream data. The system 202 may synchronize, using at least the at least one offset value, at least a portion of the video stream data with the portion of the audio stream data that corresponds to the at least one labeled object of the video stream data. The at least one data capturing characteristic may include one or more characteristics of the at least one image capturing device, one or more characteristics of the at least one audio capturing array, one or more characteristics corresponding to a location of the at least one image capturing device relative to the at least one audio capturing array, one or more characteristics corresponding to a movement of an object in the video stream data, one or more other suitable data capturing characteristics, or a combination thereof.

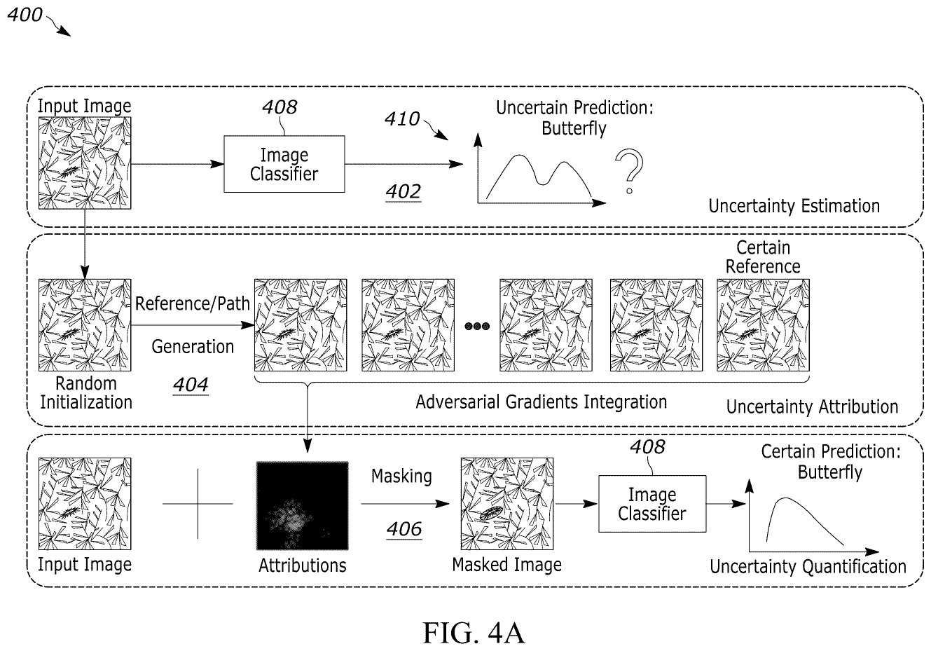

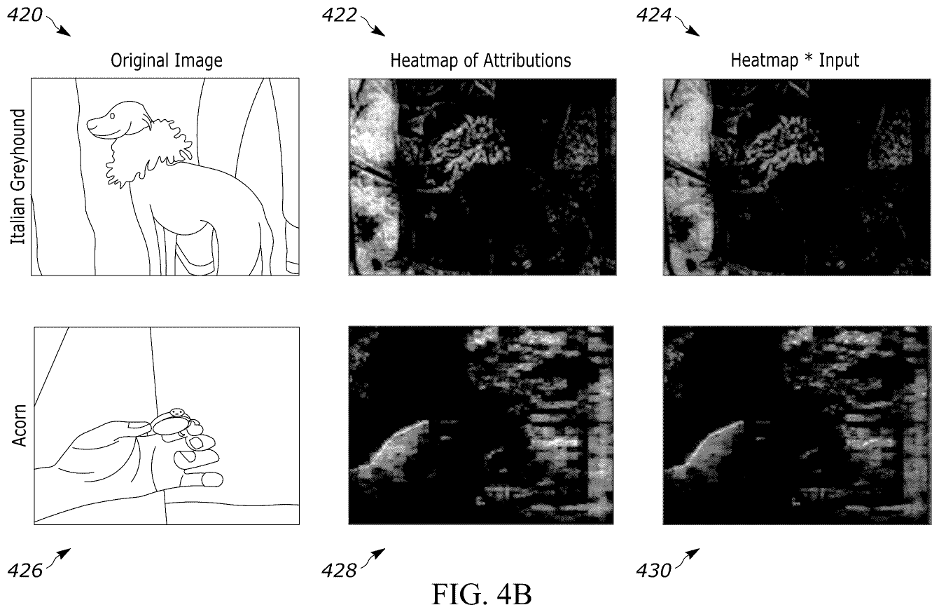

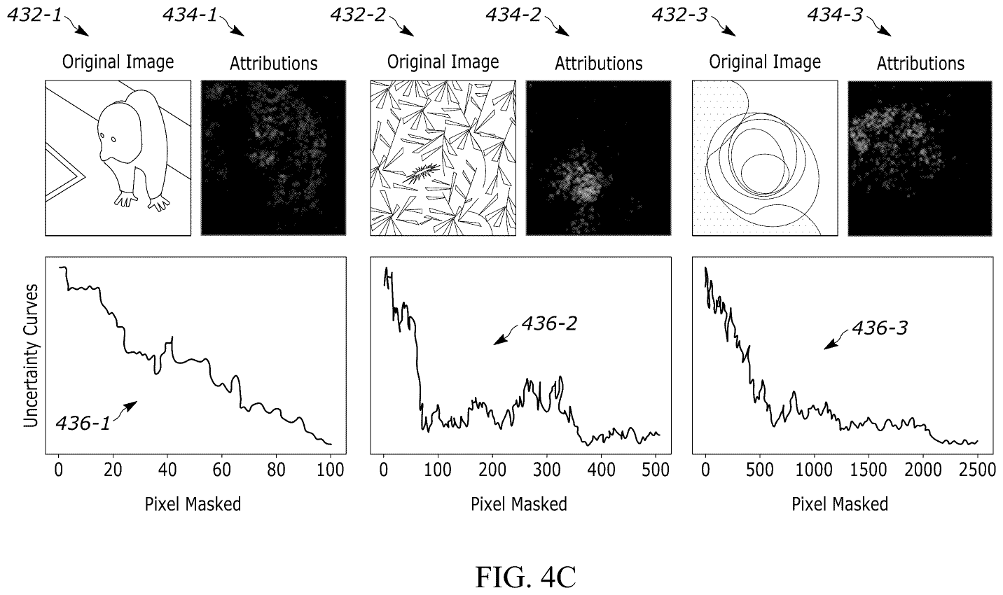

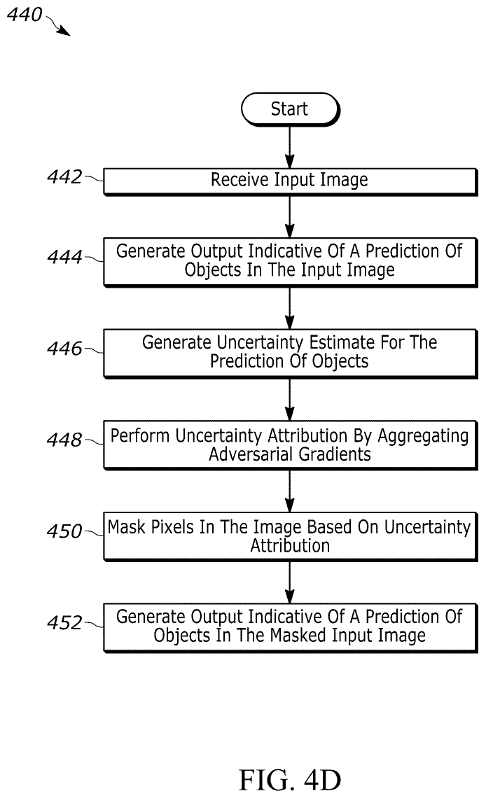

The system 202 may label, using one or more labels of the labeled objects of the video stream data and the at least one offset value, at least the portion of the audio stream data that corresponds to the at least one labeled object of the video stream data. Each respective label may include an event type, an event start indicator, and an event end indicator. The system 202 may generate training data using at least some of the labeled portion of the audio stream data. The system 202 may train a second machine-learning model using the training data. The system 202 may detect, using the second machine-learning model, one or more sounds associated with audio data provided as input to the second machine-learning model. The second machine-learning model may include any suitable machine-learning model and may be configured to perform any suitable function, such as those described herein with respect to FIGS. 4-11.

In some embodiments, as is generally illustrated in FIG. 3C, the computing system 202 may be configured to label audio data based on sensor data received from one or more sensors, such as those described herein or any other suitable sensor or combination of sensors. The system 202 may receive, from the audio capturing array 354 or any suitable audio capturing device, such as one or more of the microphones 306 or other suitable audio capturing device, audio stream data associated with a data capture environment. It should be understood that the audio capturing array 354 may include features similar to those of the audio capturing array 304 and may include any suitable number of audio capturing devices. The system 202 may receive, from at least one sensor (e.g., such as the sensor 352) that is asynchronous relative to the audio capturing array 354, sensor data associated with the data capture environment. The sensor 354 may include at least one of an induction coil, a radar sensor, a LiDAR sensor, a sonar sensor, an image capturing device, any other suitable sensor, or a combination thereof. The audio capturing array 354 may be remotely located from the sensor 354, proximately located to the sensor 354, or located in any suitable relationship to the sensor 354.

The system 202 may identify, using output from at least a first machine learning model, such as the machine learning model 210 or other suitable machine learning model, at least some events in the sensor data. The machine learning model 210 may be configured to provide output including one or more event detection predictions based on the sensor data. The system 202 may synchronize at least a portion of the sensor data associated with the portion of the audio stream data that corresponds to the at least one event of the sensor data. The system 202 may label, using one or more labels extracted for respective events of the sensor data value, at least the portion of the audio stream data that corresponds to the at least one event of the sensor data. Each respective label may include an event type, an event start indicator, and an event end indicator. The system 202 may generate training data using at least some of the labeled portion of the audio stream data. The system 202 may train a second machine-learning model using the training data. The system 202 may detect, using the second machine-learning model, one or more sounds associated with audio data provided as input to the second machine-learning model. The second machine-learning model may include any suitable machine-learning model and may be configured to perform any suitable function, such as those described herein with respect to FIGS. 4-11.

Any of the systems described above and/or below in more detail may implement uncertainty attribution systems and methods of the present disclosure, including measuring model uncertainty for classification tasks and obtaining uncertainty attribution using integrated gradients interpretation techniques.

FIG. 4A illustrates an example uncertainty attribution process 400 of the systems and methods of the present disclosure. The process 400 includes uncertainty estimation, attribution, and quantification. As shown at 402, predictive uncertainty and aleatoric and epistemic components of the predictive uncertainty can be directly estimated by the entropy of the prediction given an input image and a trained classifier. Adversarial gradients integration is shown at 404. Starting with randomly initialized points surrounding the input image (“random initialization”), references that make the prediction of the model certain by adding adversarial perturbation are generated. The adversarial gradient is then integrated throughout the generation path to attribute uncertainty to the pixels of the input image. To quantitatively evaluate the attribution, the most significant pixels are gradually masked as shown at 406. The resulting images are input into the trained classifier to determine whether the uncertainty is reduced proportionally.

For example, at 402, uncertainty estimation is performed for an output of a classifier 408 in accordance with ƒ: [symbol] ⁿ× [symbol] →Δ [symbol] ⁻¹. The weights wε [symbol] are learned to fit some available train data set [symbol] ={xᵢ, cᵢ}_{i=1,2} . . . . Thus, the function ƒ(x) maps feature vectors ×∈ [symbol] ⁿ to an element in the standard Δ [symbol] ⁻¹-simplex, which represents membership probabilities across classes in a set [symbol] . In this example, as shown at 410, the output of the classifier 408 has multiple peaks, corresponding to high probabilities of membership to different classes (e.g., “butterfly” and “flower”). Uncertainty arises due to possible membership to different classes.

Entropy is considered as a measure of predictive uncertainty H(x) in accordance with:

$$H ( x ) = - {\sum }_{c ∈ C} {f}_{c} ( x ) \cdot log {f}_{c} ( x ) , \qquad ( Equation 1 )$$

where ƒ_{c}(x) represents the predicted probability of class-c membership. In Bayesian settings, a posterior distribution p(w| [symbol] ) may be considered over weights in the model. Entropy in Equation 1 can be further decomposed into aleatoric (Equation 2) and epistemic (Equation 3) components:

$${H}_{a} ( x \vert D ) = - {\sum }_{c ∈ C} {E}_{w \vert D} [ {f}_{c} ( x , w ) \cdot log {f}_{c} ( x , w ) ] ; \qquad ( Equation 2 )$$

$$and$$

$${H}_{e} ( x \vert D ) = H ( x \vert D ) - {H}_{a} ( x \vert D ) = - {\sum }_{c ∈ C} {E}_{w \vert D} [ {f}_{c} ( x , w ) ] log {E}_{w \vert D} [ {f}_{c} ( x , w ) ] - {H}_{a} ( x \vert D ) . \qquad ( Equation 3 )$$

Aleatoric and epistemic components represent different types of uncertainties, where the aleatoric component is caused by noise from the data that is inherently noise-like (e.g., two examples with a same feature may have different outcomes) and the epistemic component is caused by inadequate data or inappropriate modeling choices.

IG interpretation may performed to generate uncertainty attribution. In an example, given a path function γ(α) for α∈[0,1], the path integrated gradients along the i^{th} dimension for an input x is defined as follows:

$${IG}_{i}^{γ} = {\int }_{α = 0}^{1} \frac{\partial F ( γ ( α ) )}{\partial {γ}_{i} ( α )} \frac{\partial {γ}_{i} ( α )}{\partial α} d α , \qquad ( Equation 4 )$$

where

$$\frac{\partial F ( x )}{\partial {x}_{i}}$$

is the gradient of F along the i^{th} dimension of input x. Here, γ(α) is parameterized as a straight path between a reference image x⁰ and the observed image x (e.g., in accordance with γ(α)=x⁰+α×(x-x⁰) for α∈[0,1]), and Equation 4 can be simplified to:

$${IG}_{i} ( x ) = ( {x}_{i} - {x}_{i}^{0} ) \times {\int }_{α = 0}^{1} \frac{\partial F ( {x}^{0} + α \times ( x - {x}^{0} ) )}{\partial {x}_{i}} d α . \qquad ( Equation 5 )$$

F(x)=ƒ_{c}(x) may represent the classification score for α specific class such that the attributions capture elements in an image that are associated with this class. In order to attribute uncertainties, H(x) is assigned to F(x), and thus all classes are considered to attempt to identify pixels that confuse the classifier models. In addition, aleatoric and epistemic uncertainty can be explained independently by assigning F(x)=Hₐ(x| [symbol] ) or Hₑ(x| [symbol] ).

While using modified integrated gradients facilitates the step of attributing uncertainty, a gap remains between the interpretation of the prediction and uncertainty. In order to attribute the prediction class of the model, the original reference input x° is set to a black image (i.e., all pixel intensities are set to zero as the absence of objects corresponds to a black image). To attribute the uncertainty, however, a reference input that the model is certain of is required. In some examples, a generative model is used to generate counterfactual cases as the reference for IG interpretation, which outperforms adaptations of common IG interpretation and variants. However, training a generative model is difficult and is only applicable to limited types of datasets, training a generative model to produce valid references from real-world datasets featuring complicated scenarios and high resolutions is not feasible.

To integrate adversarial gradients, parts of the input image are modified (e.g., iteratively), such as by introducing noise, changing pixels, etc. For example, when noise is added to the input image, relevant objects may become more readily detectable/identifiable while other objects may become less readily detectable/identifiable. As one example, respective portions of the input image corresponding to the peaks shown at 410 may be obscured by adding noise to the input image.

Accordingly, at 404, uncertainty attribution according to the present disclosure implements adversarial gradients aggregation techniques. Instead of relying on a generative model to produce a realistic reference, adversarial examples are directly generated as the references. Given the input and the trained model, adversarial cases are well-defined and straightforward to find. Here, a targeted adversarial example is clearly defined as the closest perturbed example to the original input such that it changes the prediction of the model from uncertain to certain. Integrating from an adversarial example to input in a straight line may not be optimal since a shortest path in the input space does not necessarily correspond to the shortest path in the learned feature space. Accordingly, a steepest ascent path γ(α) is selected as the integration path and the attribution of uncertainty attrᵢ is defined by:

$${attr}_{i} = {\int }_{α = 0}^{1} {∇}_{{γ}_{i}} H ( γ ( α ) ) \cdot \frac{\partial {γ}_{i} ( a )}{\partial α} d α , \qquad ( Equation 6 )$$

where the adversarial example x₀=γ(0) and a corresponding input x=γ(1). With the path defined by the steepest ascent, the following is defined:

$$\frac{\partial γ ( α )}{\partial α} d α = - \frac{{∇}_{x} H ( x )}{\vert {∇}_{x} H ( x ) \vert} d α . \qquad ( Equation 7 )$$

The negative sign in Equation 7 is a result of the direction being the opposite of the case where the adversarial example is found, which results in

$${attr}_{i} = - {\int }_{til certain} {∇}_{{x}_{i}} H ( x ) \cdot \frac{{∇}_{{x}_{i}} H ( x )}{\vert {∇}_{x} H ( x ) \vert} d α , \qquad ( Equation 8 )$$

Which is integrated along the path until H(x) is less than a threshold. In some examples, the gradient ascending may encounter local maxima that prevent further ascension. Accordingly, in some examples, the signed gradient may be used instead of the original gradient to facilitate the crossing of the decision boundary.

Since there are various reasonable explanations for uncertainty, rather than relying only on a single reference, systems and methods according to the present disclosure generate multiple references with diverse starting points. Particularly, multiplicity is achieved by randomly initializing the search starting from a ∈-sphere around the input image x. Finally, the interpretation is obtained by aggregating individual attribution from multiple starting points. The aggregation can also mitigate instability associated with gradients.

As described above, the uncertainties are interpreted by combining scores from all classes to confuse the model. However, in real-world applications, it may be desirable to determine why the model is uncertain with respect to one or more specific classes, such as the ground truth class. The techniques described herein provide references to multiple source functions and can be modified to interpret a particular class as shown below:

$${attr}_{i}^{c} = - {\int }_{til certain} {∇}_{{x}_{i}} H ( x ) \cdot \frac{{∇}_{{x}_{i}} {f}_{c} ( x )}{\vert {∇}_{x} {f}_{c} ( x ) \vert} d α , \qquad ( Equation 9 )$$

which integrates along the path until the model is certain on a specific class c. Unlike the approach described above in which uncertain references are randomly produced, the modification of Equation 9 describes the uncertainty by selecting references from a single class.

Evaluation of the uncertainty attribution of the present disclosure is described in FIGS. 4B and 4C, with continued reference to FIG. 4A. As shown at 406 in FIG. 4A, the most significant pixels are gradually masked and the resulting images are input into the trained classifier 408 to determine whether the uncertainty is reduced proportionally.

Several qualitative examples of uncertainty attributions obtained by the techniques described above are shown in FIG. 4B, which illustrates examples of heatmap interpretation of uncertainty using the systems and methods of the present disclosure. In an input image 420, prediction of a class “Italian greyhound” may be uncertain due to other objects in the image 420 having valid class designations (e.g., “jeans” and “cornflower”) in a dataset. Regions corresponding to the other objects are highlighted in heatmap images 422 and 424. In other words, the heatmap images 422 indicate objects or regions that are likely causing the predictive uncertainty of the output of the model/classifier.

Similarly, for an input image 426, the ground truth class for α target object is “turtle.” However, the relatively small size of the target object and unexpected background characteristics for α turtle (e.g., a hand, trees and leaves, etc.) cause predictive uncertainty. Consequently, the model predicts a class of “acorn”. The heatmap images 428 and 430 highlight objects/regions of the input image 426 causing the predictive uncertainty and incorrect prediction.

FIG. 4C illustrates the quantitative evaluation of the systems and methods described herein over multiple examples. Given input images 432-1, 432-2, and 432-3 and corresponding heatmap images 434-1, 434-2, and 434-3 of uncertainty attributions, pixels are masked (e.g., in order of importance as defined by attribution values) to demonstrate how masking the pixels affects the prediction uncertainty. For example, pixels in regions corresponding to the uncertainty attribution (i.e., pixels that contribute most to uncertainty) are masked. As shown at 436-1, 436-2, and 436-3, masking a portion of the pixels significantly reduces the uncertainty of the model. For example, as shown at 406 in FIG. 4A, masking the pixels corresponding to the uncertainty attributions shown in the heatmap image causes one of the peaks to be removed (and therefore increasing the certainty of the output of the classifier 408.

FIG. 4D illustrates steps of an example uncertainty attribution method 440 according to the principles of the present disclosure. For example, one or more processors or processing devices are configured to execute instructions to implement the method 440, such as one or more of the processors of the systems described herein. At 442, the method 440 (e.g., an image classifier) receives an input image. At 444, the method 400 (e.g., the classifier) generates an output indicating a prediction of objects in the input image (e.g., using a model, such as an ML model). At 446, the method 400 estimates an uncertainty of the prediction (i.e., generates an uncertainty estimation). For example, the uncertainty estimation indicates respective probabilities that the input image contains an object belonging to various classes.

At 448, the method 400 performs uncertainty attribution on the image by aggregating adversarial gradients. For example, performing uncertainty attribution may include generating a plurality of adversarial examples by introducing noise and/or other modifications to the input image and identifying regions of the image (e.g., selected pixels) corresponding to the uncertainty.

At 450, the method 400 masks selected pixels in the image based on the uncertainty attribution. For example, pixels determined to be greatest contributors to uncertainty (e.g., a predetermined number of pixels having highest attribution values) are masked in the input image. At 452, the method 400 predicts objects in the masked input image and generates an output indicative of the predicted objects.

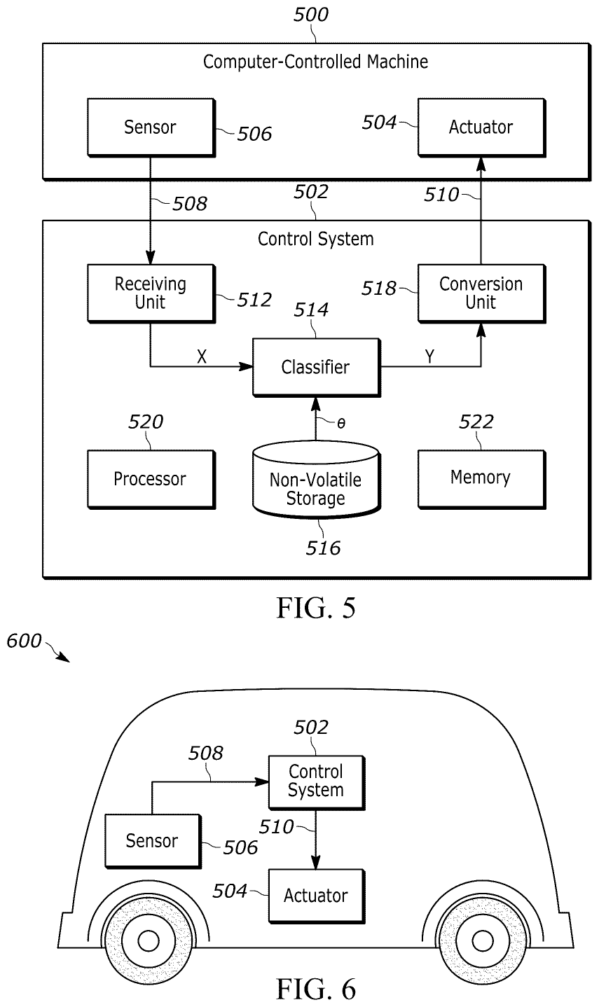

FIGS. 5-11 depict example systems and devices that may implement uncertainty attribution systems and methods according to the present disclosure. FIG. 5 depicts a schematic diagram of an interaction between a computer-controlled machine 500 and control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic and motion sensors. In some embodiments, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to produce each input signal x. Input signal x may include data corresponding to an image recorded by sensor 506.

Control system 502 includes classifier 514. Classifier 514 may be configured to classify input signals x into one or more labels using a machine-learning (ML) algorithm, such as a neural network. For example, the classifier 514 corresponds to the classifier 408 described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In some embodiments, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In some embodiments, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., ML algorithms) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more anomaly detection methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the anomaly detection methodologies as disclosed herein. Non-volatile storage 516 may also include data supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects.

In some embodiments, the vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for α sensor or camera on vehicle 600.

In some embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In some embodiments, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

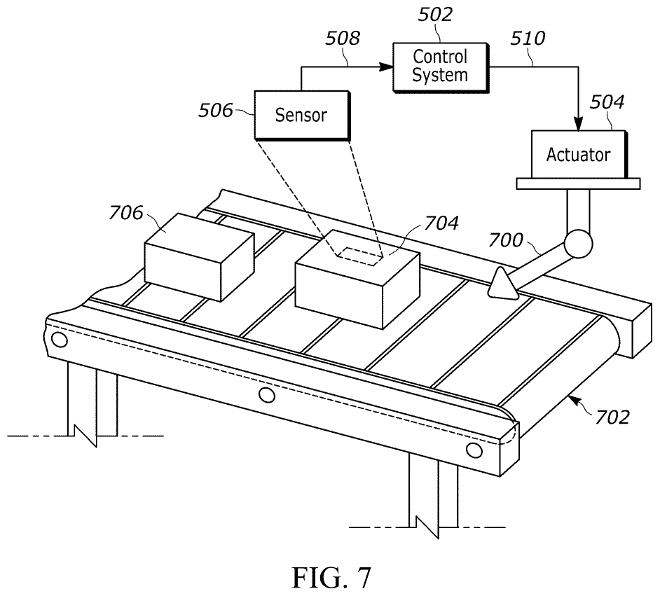

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 706 of system 700 (e.g., manufacturing machine) depending on the determined state of manufactured product 704.

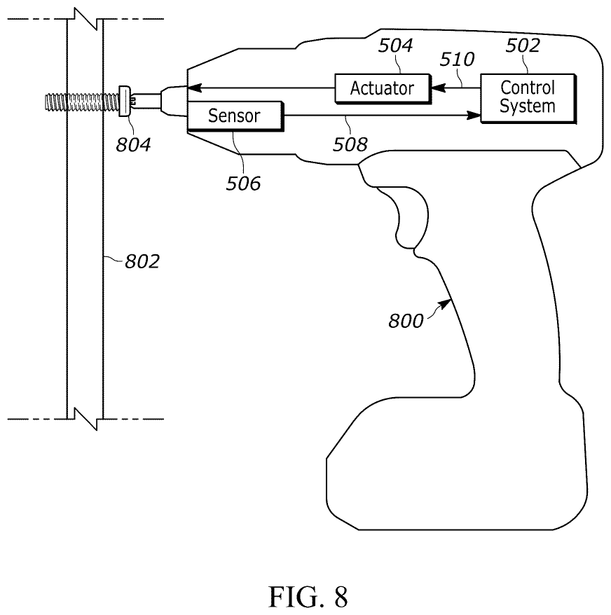

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

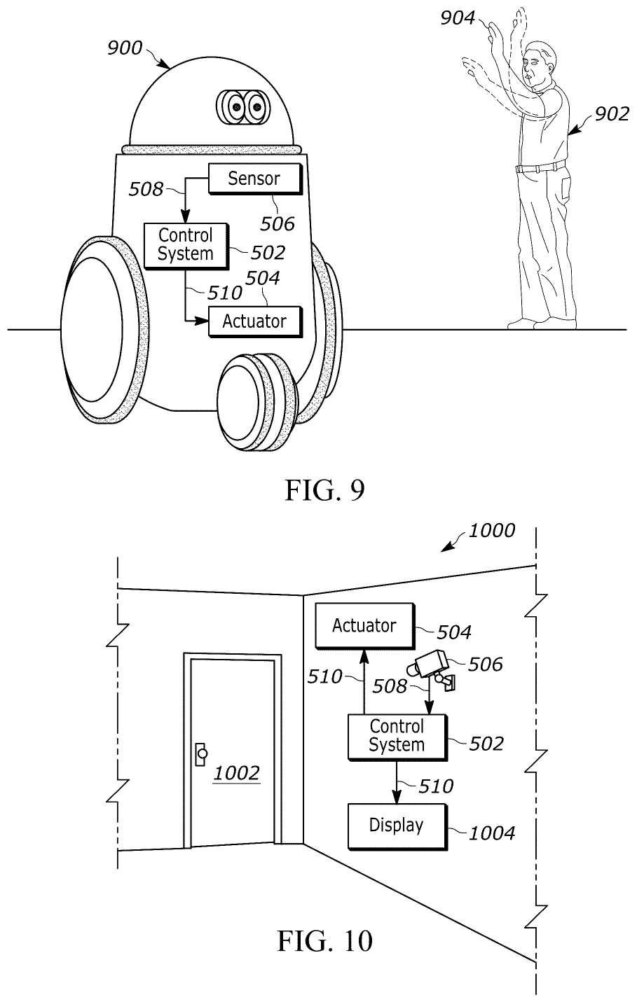

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In some embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

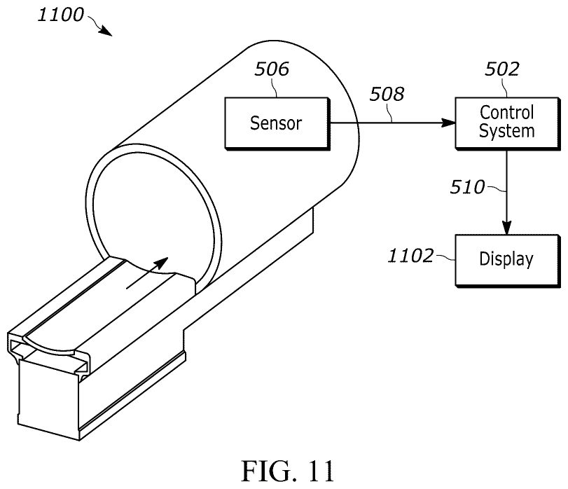

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of obtaining an uncertainty attribution of a prediction of objects in an input image, the method comprising:
receiving an input image;
generating a prediction of objects in the input image;
estimating an uncertainty associated with the prediction of the objects in the input image;
calculating an uncertainty attribution that represents regions of the input image that cause the estimated uncertainty, wherein calculating the uncertainty attribution includes generating a plurality of adversarial gradients each corresponding to a modification of the input image configured to change the estimated uncertainty; and
generating an output indicative of the calculated uncertainty attribution.

2. The method of claim 1, wherein generating the plurality of adversarial gradients includes at least one of (i) introducing noise into the input image and (ii) modifying selected pixels of the input image.

3. The method of claim 1, wherein generating the plurality of adversarial gradients includes identifying at least one adversarial gradient that causes the estimated uncertainty to decrease below a threshold.

4. The method of claim 1, wherein generating the plurality of adversarial gradients includes identifying a one of the adversarial gradients that causes the estimated uncertainty to decrease below a threshold with a least amount of modification of the input image.

5. The method of claim 1, wherein calculating the uncertainty attribution includes identifying an uncertainty attribution for α selected class of objects.

6. The method of claim 5, further comprising identifying the uncertainty attribution in accordance with
$${attr}_{i}^{c} = - {\int }_{til certain} {∇}_{{x}_{i}} H ( x ) \cdot \frac{{∇}_{{x}_{i}} {f}_{c} ( x )}{\vert {∇}_{x} {f}_{c} ( x ) \vert} d α ,$$
wherein attrᵢ^{c} corresponds to the uncertainty attribution of a class c along an integration path, H(x) corresponds to an uncertainty, and ƒ_{c}(x) corresponds to a classification score for the class c and an input x.

7. The method of claim 1, further comprising modifying the input image based on the calculated uncertainty attribution and generating a second prediction of the objects in the modified input image, wherein modifying the input image includes masking portions of the image corresponding to the calculated uncertainty attribution.

8. A computing device configured to obtain an uncertainty attribution of a prediction of objects in an input image, the computing device including a processing device configured to execute instructions stored in memory to:
receive an input image;
generate a prediction of objects in the input image;
estimate an uncertainty associated with the prediction of the objects in the input image;
calculate an uncertainty attribution that represents regions of the input image that cause the estimated uncertainty, wherein calculating the uncertainty attribution includes generating a plurality of adversarial gradients each corresponding to a modification of the input image configured to change the estimated uncertainty; and
generate an output indicative of the calculated uncertainty attribution.

9. The computing device of claim 8, wherein, to generate the plurality of adversarial gradients, the processing device is configured to execute instructions to at least one of (i) introduce noise into the input image and (ii) modify selected pixels of the input image.

10. The computing device of claim 8, wherein, to generate the plurality of adversarial gradients, the processing device is configured to execute instructions to identify at least one adversarial gradient that causes the estimated uncertainty to decrease below a threshold.

11. The computing device of claim 8, wherein, to generate the plurality of adversarial gradients, the processing device is configured to execute instructions to identify a one of the adversarial gradients that causes the estimated uncertainty to decrease below a threshold with a least amount of modification of the input image.

12. The computing device of claim 8, wherein, to calculate the uncertainty attribution, the processing device is configured to execute instructions to identify an uncertainty attribution for α selected class of objects.

13. The method of claim 12, wherein the processing device is configured to execute instructions to identify the uncertainty attribution in accordance
$${attr}_{i}^{c} = - {\int }_{til certain} {∇}_{{x}_{i}} H ( x ) \cdot \frac{{∇}_{{x}_{i}} {f}_{c} ( x )}{\vert {∇}_{x} {f}_{c} ( x ) \vert} d α ,$$
wherein attrᵢ^{c} corresponds to the uncertainty attribution of a class c along an integration path, H(x) corresponds to an uncertainty, and ƒ_{c} (x) corresponds to a classification score for the class c and an input x.

14. The computing device of claim 8, wherein the processing device is configured to execute instructions to modify the input image based on the calculated uncertainty attribution and generate a second prediction of the objects in the modified input image, and wherein, to modify the input image, the processing device is configured to execute instructions to mask portions of the image corresponding to the calculated uncertainty attribution.

15. A computer-controlled machine, comprising:
at least one sensor configured to generate an input image;
a control system configured to
receive an input image,
generate a prediction of objects in the input image,
estimate an uncertainty associated with the prediction of the objects in the input image,
calculate an uncertainty attribution that represents regions of the input image that cause the estimated uncertainty, wherein calculating the uncertainty attribution includes generating a plurality of adversarial gradients each corresponding to a modification of the input image configured to change the estimated uncertainty, and
generate an output signal indicative of the calculated uncertainty attribution; and
an actuator configured to control an operation of the computer-controlled machine in response to the output signal.

16. The computer-controlled machine of claim 15, wherein, to generate the plurality of adversarial gradients, the control system is configured to execute instructions to at least one of (i) introduce noise into the input image and (ii) modify selected pixels of the input image.

17. The computer-controlled machine of claim 15, wherein, to generate the plurality of adversarial gradients, the control system is configured to execute instructions to identify at least one adversarial gradient that causes the estimated uncertainty to decrease below a threshold.

18. The computer-controlled machine of claim 15, wherein, to generate the plurality of adversarial gradients, the processor is configured to execute instructions to identify a one of the adversarial gradients that causes the estimated uncertainty to decrease below a threshold with a least amount of modification of the input image.

19. The computer-controlled machine of claim 15, wherein the control system is configured to execute instructions to modify the input image based on the calculated uncertainty attribution and generate a second prediction of the objects in the modified input image.

20. The computer-controlled machine of claim 15, wherein the computer-controlled machine includes an autonomous robot.
